(19) United States
(12) Patent Application Publication
(10) Pub. No.: US 2006/0038394 A1
(43) Pub. Date: Feb. 23, 2006

(54) Album for storing and displaying three-dimensional items of memorabilia

(76) Inventor: Deborah A. Henley, Lawrenceville, GA (US)

Correspondence Address: WOMBLE CARLYLE SANDRIDGE & RICE, P.O. Box 7037, Atlanta, GA, 30357-0034, US

(21) Appl. No.: 10/924,212

(22) Filed: Aug. 23, 2004

(51) Int. Cl. B42D 1/00

(52) U.S. Cl. 281/21.1

(57) ABSTRACT

A storage album for three dimensional memorabilia has an openable top panel, a bottom panel, side panels, and a spine defining an interior volume. The spine is detachably secured to the back ends of two of the side panels so that it is held in place along and defining the spine of the album when the top cover is closed, but is detached and lays flat and coextensive with the top and bottom panels when the top panel is fully opened. This allows the pages or protectors of the album to be turned fully back for viewing three dimensional items stored for display therein.

### FIELD OF THE INVENTION

The present invention relates generally to storage cases and, more particularly, to an album for storing and displaying three-dimensional items of memorabilia, or the like.

### BACKGROUND OF THE INVENTION

Conventional memorabilia albums are normally constructed like books. Transparent display pages (protectors) are secured to the spine of the album, or held in a stacked array by a ring-binder or clamping device. Albums constructed in this fashion are useful for storing and displaying items that are substantially flat such as photographs, autographs, newspaper articles, etc.

These conventional memorabilia albums, however, are not suitable for storing and displaying items that not flat, i.e., three-dimensional. Any attempt to store such three-dimensional items would defeat the functionality and appearance of the conventional book-like album.

The currently known ways in which to store three-dimensional, or bulky, items or memorabilia are shoe boxes, lock boxes, drawers, etc. Other than being aesthetically unattractive and bulky, these storage containers lack the functionality of displaying items stored therein in an organized fashion. Rather, the user must remove the items from such containers and place them on a display surface.

What is needed is a memorabilia storage and display construction that provides the functionality of a conventional album, yet is capable of storing and displaying three-dimensional items of memorabilia.

### SUMMARY OF THE INVENTION

The present invention is directed to an album for storing and displaying three-dimensional items of memorabilia; however, the album described herein will find utility in the storage and display of other types of three-dimensional items.

A first aspect of the present invention is directed to an album that comprises conventional top and bottom covers, each cover having a front edge and a rear edge. A generally rectangular spine hingedly connects the rear edges of the top and bottom covers. Unlike conventional albums, however, the album of the present invention includes opposed end walls and a side wall that extend between the bottom and top covers and that will optimally project upwardly from the bottom cover. As constructed, the top and bottom covers, opposed end walls, side wall, and spine define an inner storage volume. A retainer, such as a ring-binder mechanism, is secured proximate the rear edge of the bottom cover with conventional fasteners or adhesives that are used in the construction of ring-binders.

Unlike other binders and albums known in the art, the spine of the present invention is releasably attachable to rear portions of the side walls. In a preferred embodiment, magnets, or magnetically attracted elements, are affixed to flanged surfaces that extend inwardly from the rear edges of the end walls and to end portions of the spine. These are easily engaged and released by a user. Alternatively, a closure device such as hook and loop fastening material may be affixed to the flanged surfaces and to the spine.

To maintain the cover in a closed, secure fashion, a closure flap or flange may be connected to and extend downwardly from the front edge of the top cover. A latch optionally may be affixed to the closure flap and the side wall to further secure the album in a closed configuration. The latch may be in the form of a clasp, snap, hook and loop material, etc.

### BRIEF DESCRIPTION OF THE DRAWINGS

FIG. 1 is a top perspective view of the memorabilia album of the present invention;

FIG. 2 is a top perspective view of the memorabilia album of FIG. 1 showing the album with the front cover opened;

FIG. 3 is a top perspective view of the memorabilia album of FIG. 1 showing the album with the front cover and spine completely opened; and

FIG. 4 is a top perspective view of the memorabilia album of FIG. 1 illustrating in greater detail the releasably attachable spine of the memorabilia album of the present invention.

### DETAILED DESCRIPTION OF THE PREFERRED EMBODIMENTS

Certain exemplary embodiments of the present invention are described below and illustrated in the attached Figures. The embodiments described are only for purposes of illustrating the present invention and should not be interpreted as limiting the scope of the invention, which, of course, is limited only by the claims below. Other embodiments of the invention, and certain modifications and improvements of the described embodiments, will occur to those skilled in the art, and all such alternate embodiments, modifications and improvements are within the scope of the present invention.

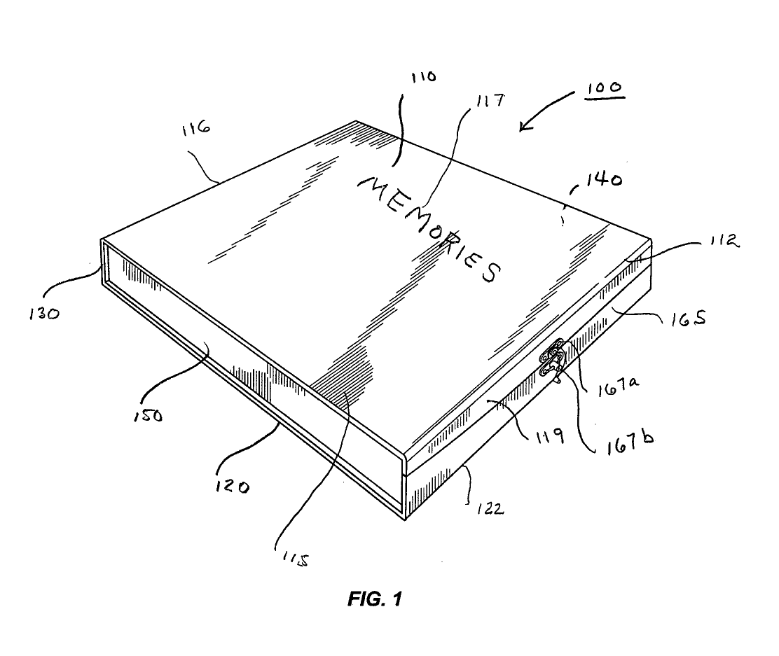

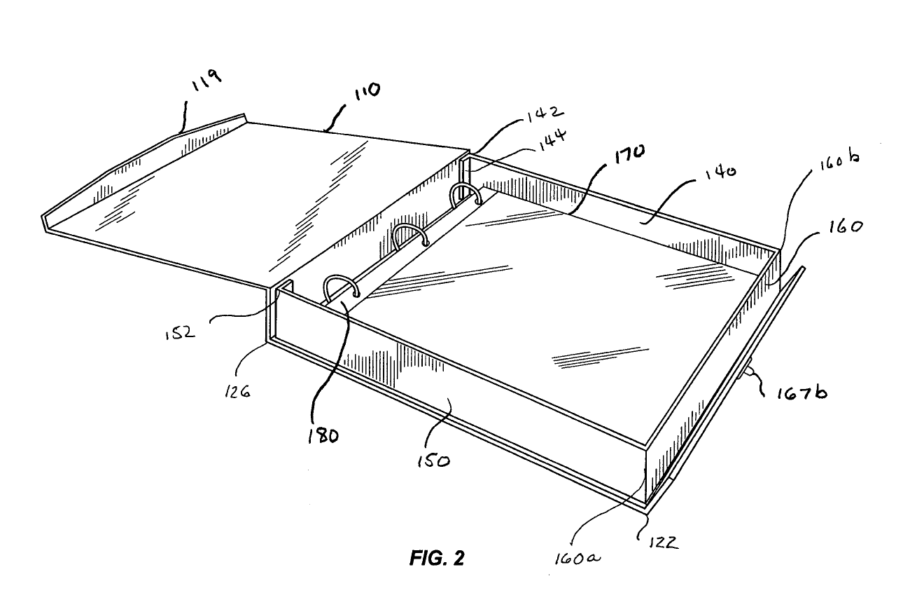

Referring first to FIGS. 1 and 2, the present invention is directed to an album, shown generally as 100, for storing and displaying three-dimensional items of memorabilia, or the like.

The album 100 of the present invention comprises a top cover 110, a bottom cover 120, a spine 130, opposed end walls 140, 150, and a side wall 160. The covers 110, 120, spine 130, end walls 140, 150, and side wall 160 define a storage volume having a volume that approximates the area of one of the covers 110, 120 times the height of an end or side wall.

As will be appreciated in the art, albums of the type described herein are typically constructed of a semi-rigid or rigid paperboard or cardboard semi-rigid or rigid paper, or a suitable synthetic stock material that is subsequently coated or covered with a thin protective layer 115 of plastic or fabric material for protective and aesthetic purposes.

The top cover 110 is of a generally planar, rectangular (book-like) shape, having a front edge 112 and a rear edge 116. The protective layer 115 may optionally have printed or fanciful indicia 117 formed thereon to identify the nature of the album. In one embodiment, a closure flap 119 extends downwardly from the front edge 112 of the top cover 110. The closure flap 119 may be either hingedly connected to the top cover 110, or alternatively, may be more rigidly connected to the top cover 110 so that it is generally perpendicular to the surface of the top cover 110.

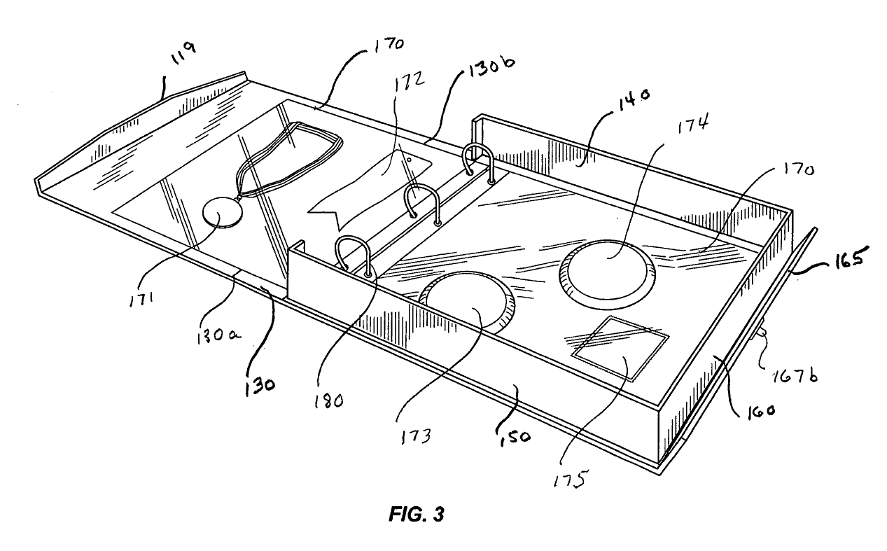

The bottom cover 120 is formed similar to the top cover 110 with similar shape and dimensions. The bottom cover 120 also comprises a front edge 122 and a rear edge 126. Opposed end walls 140, 150 extend between the upper and lower ends of the bottom cover 120 and the top cover 110. The end walls 140, 150 project upwardly a height sufficient for the storage of three-dimensional items of memorabilia. Each end wall further comprises a rear portion 142, 152. A side wall 160 also projects upwardly from the front end of the bottom cover and connects with the end walls 140, 150 at corners 160a, 160b. In one embodiment, the end walls 140, 150 and side wall 160 extend upwardly from the bottom cover 120. The manner in which the end walls 140, 150 and the side wall 160 are formed and attached is not critical to the present invention; rather, the walls may be formed as a single piece and bent to form the three walls. Further, the walls may be attached to the bottom cover 120 in any of the ways in which notebook type constructions are connected; e.g., adhesives, clips, cover 115, etc. As best seen in FIGS. 2 and 3, a supplemental lower closure flap 165 may be hingedly connected to the front edge 122 of the bottom cover for cooperating closure with the closure flap 119. A two piece latch 167, or clasp, may be affixed to the closure flaps 119, 165 for mating engagement when the album 100 is configured for storage. The latch 167 maintains the album 100 in a closed condition. As those skilled in the art will appreciate, the latch 167 may comprise any number of known latching or fastening constructions and materials.

A generally rectangular spine 130 hingedly connects the rear edges 116, 126 of the top 110 and bottom 120 covers. The spine has a height that approximates the height of the end walls 140, 150, and the side wall 160 and comprises opposed end portions 130a, 130b. As constructed, top cover 110, bottom cover 120, end walls 140, 150, side wall 160, and spine 130 define a storage volume that approximates the area of the top or bottom cover multiplied by the height of the walls 140, 150, 160.

To secure storage sleeves (such as transparent pockets) 170, or item protectors, within the volume of the album 100, a retainer 180 is affixed to the rear portion of the bottom cover 120. Where the retainer is intended to hold sheets 170, the retainer 180 is desirably a ring-binder, such as a three ring-binder, or the like. Alternatively, the retainer 180 may be a clamping or clasping device, one or more clips, etc., depending upon the nature of the item holders and the items to be secured within the album 100.

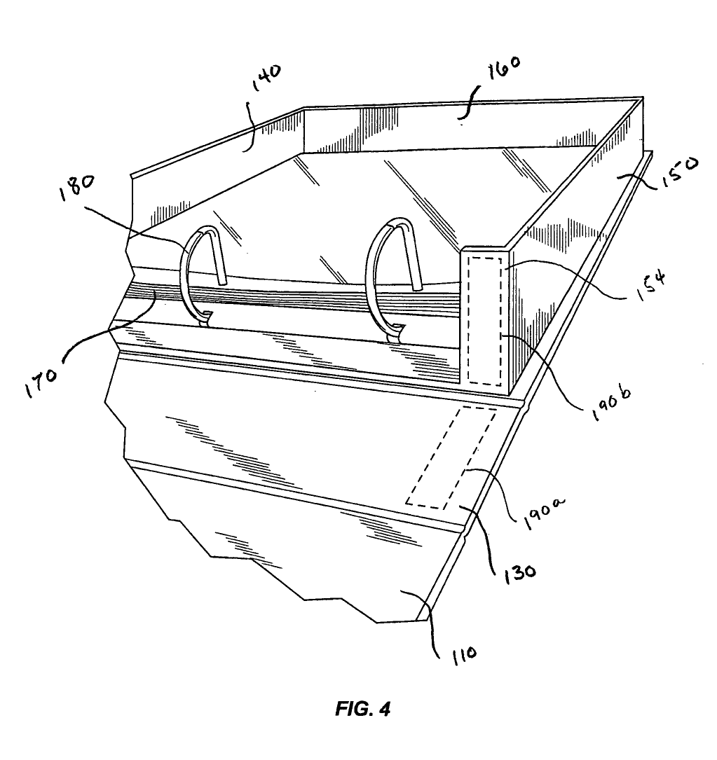

Unlike the prior art, the opposed end portions 130a, 130b of the spine 130 of the album 100 are releasably attachable to the rear portions 142, 152 of the opposed end walls 140, 150. Thus, the top cover 110 and the spine 130 are outwardly extensible, as best seen in FIG. 3. To enable the spine 130 to be releasably attachable to the end portions 142, 152 of the opposed end walls, inwardly extending flanges 144, 154 are connected to the end portions 142, 152 of the opposed side walls to provide closure surfaces. As best seen in FIG. 4, a closure device 190, typically comprising a two-piece closure 190a, 190b, is affixed to the end portions 130a, 130b of the spine 130 and to the inwardly extending flanges 144, 154. In one embodiment, the closure device 190 comprises a magnet 190a and another magnet or magnetically attractive metallic element 190b, although these two pieces could be oppositely positioned. As constructed, and for aesthetic reasons, the two pieces of the closure device 190 may be positioned between the cardboard or paper stock and the cover layer 115, although they may well be visible. In an alternative embodiment, the closure device may comprise hook and loop closure material, such as VELCRO®. In this case, the closure material would be visible and attached to the outside of the flanges 144, 154 and the end portions 130a, 130b of the spine 130. As constructed, therefore, the spine 130 is releasably attachable to the end walls, but remains attached to the rear edge 126 of the bottom cover 120, even when extended outwardly for display purposes.

Starting with the album 100 in the closed position shown in FIG. 1, a user will first unlatch the latch 167, or clasp. The front cover 110 can then be opened upwardly and outwardly. By continuing to extend the front cover 110 outwardly, the spine 130 will detach from the end walls 140, 150 so that the spine 130 and top cover 110 are substantially flat against the surface of a table, or the like, for display purposes. The sleeves 170 can then be turned outwardly to display the enclosed items of memorabilia 171-175. When the user has finished viewing the items, the sleeves 170 are one again turned, or folded, inwardly into the volume of the album 100. The top cover 110 and spine 130 are closed, securing the spine 130 to the end walls 140, 150. Thereafter, the latch 167 is secured and the album 100 is ready for storage.

Although the present invention has been described with exemplary embodiments, it is to be understood that modifications and variations may be utilized without departing from the spirit and scope of the invention, as those skilled in the art will readily understand. Such modifications and variations are considered to be within the purview and scope of the appended claims and their equivalents.

We claim:

1. An album for three-dimensional items, comprising:
(a) a top cover having a front edge and a rear edge;
(b) a bottom cover having a front edge and a rear edge;
(c) a generally rectangular spine hingedly connecting the rear edges of the top and bottom covers, said spine having opposed end portions;
(d) opposed end walls extending between the bottom cover and the top cover, said opposed end walls having rear portions;
(e) a side wall extending between the bottom cover and the top cover;
(f) said top cover, bottom cover, opposed end walls, side wall, and spine defining a storage volume;
(g) a retainer for securing items of memorabilia therein the storage volume; and
(h) the opposed end portions of the spine being releasably attachable to the rear portions of said end walls, wherein said top cover and said spine are outwardly extensible.

2. The album of claim 1 further including a closure device for releasably attaching the opposed end portions of the spine to the rear portions of said opposed end walls.

3. The album of claim 2 wherein the closure device comprises a hook and loop fastening material.

4. The album of claim 2 wherein the closure device comprises magnetically attractive elements positioned in said opposed end portions of said spine and said rear portions of said opposed end walls.

5. The album of claim 1 further comprising opposed flanges, said flanges extending inwardly from the rear portions of said end walls.

6. The album of claim 5 further including a closure device for releasably attaching the opposed end portions of said spine to the opposed flanges of said end walls.

7. The album of claim 6 wherein the closure device comprises a hook and loop fastening material.

8. The album of claim 6 wherein the closure device comprises magnetically attractive elements positioned in said opposed end portions of said spine and said opposed flanges of said end walls.

9. The album of claim 1 further including a closure flap extending downwardly from the front edge of said top cover.

10. The album of claim 1 further including a latch for securing said closure flap to said front wall.

11. The album of claim 10 wherein said latch is a clasp.

12. The album of claim 1 wherein the retainer is a ring-binder.

13. The album of claim 12 where the ring-binder is a three ring-binder.

14. A storage album having an openable top cover, a bottom cover, sides, and a spine having opposed edges, said covers, sides, and spine defining an interior volume for storing objects when said top cover is closed, said spine of said storage album being hingedly attached along one edge to an edge of said bottom cover and along its opposed edge to an edge of said top cover, said spine further being detachably secured in a first position perpendicular to said top and bottom covers when said top cover is closed and being movable when detached to a second position coextensive with said top and bottom covers when said top cover is open.

15. A storage album as claimed in claim 14 and wherein said spine is detachably secured magnetically.

16. A storage album as claimed in claim 14 and wherein said spine is detachably secured with hook and loop fasteners.

17. A storage album as claimed in claim 14 and wherein tow of said sides have in-turned flanges and wherein said spine is detachably secured to said in-turned flanges.

18. A storage album as claimed in claim 17 and wherein said spine is magnetically secured to said in-turned flanges.

19. A storage album as claimed in claim 17 and wherein said spine is secured to said in-turned flanges by hook and loop fasteners.
